(19) United States
(12) Patent Application Publication
(10) Pub. No.: US 2003/0084071 A1
(43) Pub. Date: May 1, 2003

(54) Method and system for managing computer performance

(75) Inventor: Bernard Iulo, Poughkeepsie, NY (US)

Correspondence Address: Philmore H. Colburn II, Cantor Colburn LLP, 55 Griffin Road South, Bloomfield, CT, 06002, US

(73) Assignee: INTERNATIONAL BUSINESS MACHINES CORPORATION, ARMONK, NY

(21) Appl. No.: 10/002,505

(22) Filed: Nov. 1, 2001

(51) Int. Cl. G06F 12/00

(52) U.S. Cl. 707/200

(57) ABSTRACT

An exemplary embodiment of the invention relates to a method and system for managing computer performance. The system comprises a server connected to a network link and a data storage device in communication with the server. The data storage device provides a repository for a system activity database which stores activity records and environmental records created by a system monitor application, as well as an auxiliary database which stores historical records transferred from the system activity database. The system also includes a client system in communication with the server, a user interface for the system monitor program that is executable by the server, and a system activity analysis program executable by the server. Upon execution of the system activity analysis program, the server searches the system activity and auxiliary databases, retrieves data relating to a request for analysis of a task, and presents the data to a user on the client system.

### BACKGROUND

This invention relates generally to managing computer system performance, and more particularly, the present invention relates to a method and system for tracking and logging system environmental and task information during successful and uninterrupted system operations for use in diagnosing future system problems.

During their execution, tasks, jobs, or programs running on various computer operating systems commonly experience errors. A minor error, such as where a task completes successfully although a warning appears which requires review, is a frequently occurring error and is one that, fortunately for the user, causes little or no damage. A severe error, such as where a task unexpectedly terminates without completing (also referred to as an abend), can cause significant harm to a running application.

Historically, diagnosing and correcting these problems involved examining the error data provided at the time of the failure, determining what was not working correctly, and eventually providing a fix or a recommendation that allowed the task to work properly. Most operating systems on the market today include methods of capturing an image of system activity at the time of the failure (referred to as a dump), a chronological mapping of system activity before and during a failure (referred to as a trace), or a log of system and task errors and environmental data also around the time of the problem (error logs).

This data is effective for many problems a task may encounter. But as the complexity of operating systems continues to increase and the dynamics of the computing environment continue to change, coupled with the variety and number of independent vendors and programmers introducing changes to operating systems, the frequency and complexity of problems associated with these events continues to challenge system analysts. Meeting these challenges requires more than the traditional environmental techniques, but also an understanding of the full scope of this expanding environment.

Currently, when questions about system changes and past successful task processing arise, the data available is usually based upon the recollection of an individual system programmer. This often results in error-prone analyses and incomplete data. Changes can occur in so many ways and so frequently that it is becoming impractical to rely on the memory of an individual who may not even be aware of all of the changes taking place.

What is needed, therefore, is a method and system that will address this new and expanding set of complex system problems in a disciplined and precise manner.

### BRIEF SUMMARY

An exemplary embodiment of the invention relates to a method and system for managing computer performance. The system comprises a server connected to a network link and a data storage device in communication with the server. The data storage device provides a repository for a system activity database which stores activity records and environmental records created by a system monitor application, as well as an auxiliary database which stores historical records transferred from the system activity database. The system also includes a client system in communication with the server, a user interface for the system monitor program that is executable by the server, and a system activity analysis program executable by the server. Upon execution of the system activity analysis program, the server searches the system activity and auxiliary databases, retrieves data relating to a request for analysis of a task, and presents the data to a user on the client system.

### BRIEF DESCRIPTION OF THE DRAWINGS

Referring now to the drawings wherein like elements are numbered alike in the several FIGURES:

FIG. 1 is an exemplary system diagram of a computer network upon which the system monitor program and system activity analysis program are implemented in a preferred embodiment; and

FIG. 2 is an exemplary flowchart illustrating the process of resolving system errors via the execution of the system activity analysis program tool.

### DETAILED DESCRIPTION OF THE PREFERRED EMBODIMENT

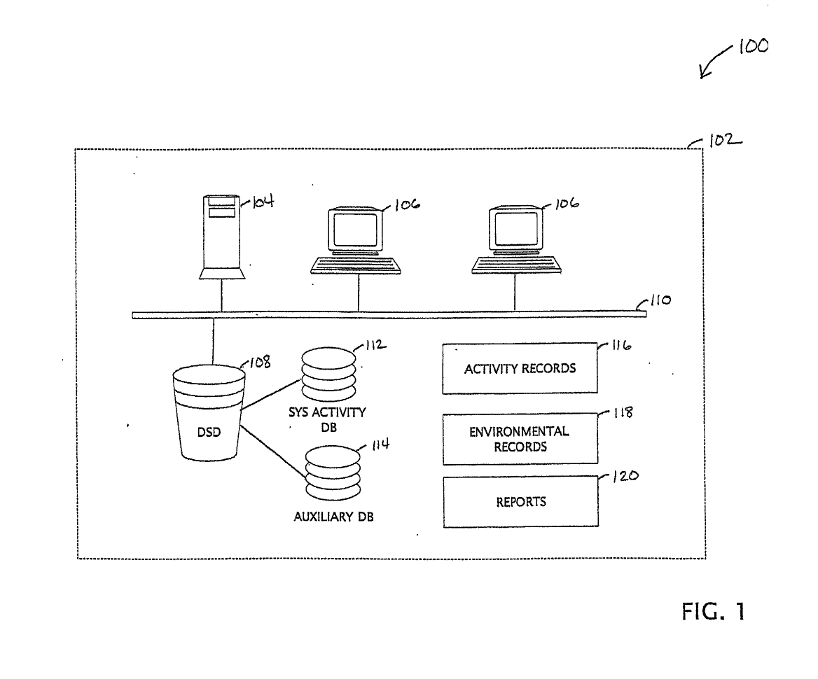

In an exemplary embodiment, the system monitor program and system activity analysis program are implemented in a network environment as shown in FIG. 1. System 100 includes an enterprise 102 including a server 104, client systems 106, a data storage device 108, and a network link 110 for enabling entities of enterprise 102 communicate with one another.

Enterprise 102 may be a commercial establishment such as a business enterprise. Server 104 may be operating various software applications for enabling entities of enterprise 102 to communicate with each other as well as perform various enterprise level tasks. Software applications may include enterprise resource planning software, web server and applications server software, groupware, email software, database management software, and other tools commonly used in a business environment. Server 104 is also executing system monitor software for capturing system activities and related environmental data.

Server 104 is also executing the system activity analysis program tool of the invention. The system activity analysis program tool is invoked by an authorized user, preferably a system administrator, analyst, or programmer for enterprise 102, when traditional methods of debugging a problem detected on a system device have failed. These scenarios may include cases where a routinely-executed task, having a previous record of successful execution, has recently failed.

Data storage device 108 stores databases of records generated by the system monitor program and provides a summary of activities which have occurred over a specified period of time. Databases housed in data storage device 108 include a system activity database 112 and an auxiliary database 114. System activity database 112 stores activity records 116 and environmental records 118 generated and provided by the system monitor tool. Auxiliary database 114 stores historical data periodically transferred from system activity database 112 for future reference. Reports records 120 are also available via the system activity analysis program tool for reference and/or trend analyses.

The system monitor program captures specified elements about the successful execution of a job or task. It also captures key environmental information including items such as system resources requested and used (e.g., amount of storage, critical locks/latches held, dataset/files, execution time) and saves this information in system activity database 112. When a task is started, the monitor captures the task name, start time, data sets/files allocated, initial storage in an activity record. As the task executes, the system monitor captures other execution variables such as system locks/latches used, storage used, and status of any sub-tasks performed. This function of the system monitor continues as long as the task is active. As required, more information may be added to the activity record.

When the task completes, the system monitor will complete the tracking of the task by including in the activity record the end time for the task, locks/latches freed, storage used, data sets/files updated, and the final status on the completion of the task. Upon completion of the task, the resulting activity record is written to system activity database 112.

The activity record is used to track the details relating to the execution of a specific task. The format of activity record 116 is illustrated below.

Activity record identifier
Activity flags
Unique Task Name
Initial Storage Allocated
Name of Initial Program Called
Pointer to List of Additional Storage Requests
Count of Number of Additional Storage Requests
Pointer to List Data Sets/Files used
Count of Number of Data Sets/Files
Pointer to List of Latches/Locks Used
Count of Number of Latches/Locks Used
Execution Start Time
Execution End Time

Definitions of fields provided in activity records 116 are provided below.

Activity Record Identifier. X′AAAAAAAA0001′

Activity Flags. Special task indicator flags include a positive indicator if the task has completed successfully and a negative indicator if the task has not completed successfully.

Unique Task Name. A unique name (up to 1024 bytes) that is assigned to the task by an authorized system user.

Initial Storage Allocated. The number of initial bytes of storage, either set or defaulted, that is assigned by the installation.

Name of Initial Program Called. The name of the first program that gets invoked for the task.

Pointer to a List of Additional Storage Requests. A pointer to another table which includes all additional storage requests, time made, amount of storage requested and indicators to note if the storage has been freed.

Count of Number of Additional Storage Requests. A counter to keep track of the number of additional storage requests made.

Pointer to a List of Data Sets/Files Used. A pointer to another table which includes all data set names or file names used by the program.

Count of Number of Data Sets/Files Used. A counter to keep track of the number of data sets/files used.

Pointer to a List of Locks/Latches Used. A pointer to another table which includes all locks and latches used by the program as well as an indicator for when the latch/lock is freed.

Count of Number of Latches/Locks Used. A counter to keep track of the number of latches/locks used.

Execution start time. System time stamp at task start.

Execution end time. System time stamp at task end.

Environmental records 118 may be provided for every unique system or application program available on enterprise system's 102 operating system. These records 118 are used to monitor system change activity and are input to the analysis program. Many operating systems today provide a variety of installation tools that gather much of this data. The system monitor program includes an interface that can be invoked to monitor these environmental changes. The format of environmental record 118 is shown below.

Environmental Record Identifier
Environmental Flags
Program or Product Name
Time Stamp for Change, Addition, or Deletion
Name of OEM Vendor for Product
Phone Number for Contact at OEM Vendor

Field definitions for environmental record 118 are described below.

Environmental record identifier. X′EEEEEEEE0001′

Environmental flags. Task indicator flags including indicators that classify a task as a software program, a hardware product, an initial entry, a change to the program or product, a removal of a program or a product, a change in the name of an OEM vendor, or a change in the contact phone number.

Time stamp. A system time stamp indicating when the event described in the environmental record took effect.

Name of OEM (original equipment manufacturer) vendor for product. The name of the OEM manufacturer or developer of the product in this environment record.

Phone number for contact at OEM vendor. Phone number of technical person responsible for servicing this program.

System activity database 112 is the repository for all activity and environmental records, 116 and 118 respectively, generated during the execution of the system monitor tool. Preferably, this repository has an allocation sufficient to contain at least one full day of system operation. Further, all records 116 and 118 stored in system activity database 112 will preferably be off loaded to auxiliary database 114 on a daily basis for potential later use.

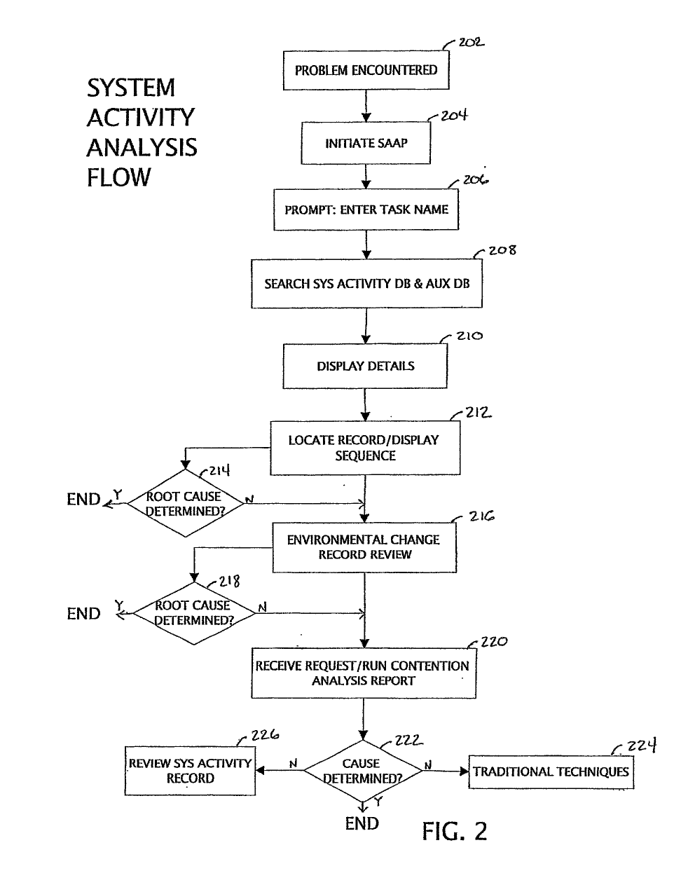

The system activity analysis program tool may be initiated by an authorized user of enterprise system 102 when a problem has been discovered concerning a job or task running on an entity of enterprise system 102 for which traditional debugging techniques have failed. FIG. 2 illustrates the process of resolving a system error detected by a system user utilizing the system activity analysis program tool. At step 202, a system error has been encountered by a user of one of client systems 106. Traditional debugging techniques have been exhausted and so the system administrator invokes the system activity analysis program application via one of client systems 106 at step 204. The system activity analysis program tool prompts the administrator to enter a task name relating to the task being analyzed at step 206. Once entered, the system activity analysis program tool searches system activity database 112 and auxiliary database 114 for all previous executions of the identified task at step 208. Details of previous executions found in the activity record for the task are then displayed and/or printed out for the administrator at step 210. Details are provided for each previous execution of the task up to and including the time that the problem occurred.

The system activity analysis program tool next locates the activity record for the failing execution at step 212 and presents it to the administrator for review. This record includes the sequence of task activities which reveal how far the task executed and what it was doing when the problem occurred. From this information, the administrator may be able to determine the root cause of the problem (step 214). If so, the administrator exits the program and takes corrective action according to the information received. If no cause is apparent to the administrator (step 214), the administrator may continue by requesting a listing of previous environmental change records created between the last successful execution of the program up to the time of the failure at step 216. The tool retrieves these records from system activity database 112 and presents them to the administrator at client system 106 for review. From this information, the administrator may be able to determine if the root cause is related to a system or program change. Again, the administrator may have enough information to determine the root cause of the failure (step 218). If so, the administrator may exit the program and take appropriate corrective action. If the cause is not apparent, however, the administrator may request that the system activity analysis program tool run a contention analysis report which will map out locks/latches obtained and also identify locks/latches held by other tasks in system activity database 112 at step 220. If still no cause is determined (step 222), the administrator now has more detailed information directed to activities occurring at and near the time of the failure with which to perform traditional problem analysis such as system dumps and traces at step 224. The administrator may also utilize the system activity record for the task generated by the system monitor tool as a task-level trace that can be validated against any successful task runs at step 226. If this is the first execution of a task on this system, obviously there is no successful activity record to trace against, however, the ‘task-tracing’ included in the failing system activity record and the system activity analysis program contention analysis report would still provide much more detail than is currently available by traditional analysis tools and techniques.

The system activity analysis program tool provides a mechanism for tracking the successful execution of various jobs and tasks routinely running in a system. It captures specified environmental information including system resources requested and used, and saves this information in a database, providing a task profile which is continually updated each time the same job or task is executed successfully. The tool also logs specified system environmental factors at various points during the ongoing running of a computer system, including system changes made such as new products installed and changes to the operating system. An analysis routine provided by the tool may also be invoked when a system problem is encountered and provide information to the person diagnosing the problem including profiles for any jobs/tasks running on the system during the time of the problem. The invention may help identify abnormal variations in job or task characteristics from normal execution, potential contention and storage issues, and also a history of any changes in the system environment since the last point these tasks ran successfully.

By tracking system activities and environmental changes, the tool can save system administrators valuable time and resources that would otherwise be necessary in investigating these problems. Detailed account management profiles of the operating environment provide useful information in assisting the administrator in resolving these problems. Further environmental records provide a facility available to identify by program either a direct contact that can work on resolving a problem or the number for a support center to handle the problem.

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While preferred embodiments have been shown and described, various modifications and substitutions may be made thereto without departing from the spirit and scope of the invention. Accordingly, it is to be understood that the present invention has been described by way of illustration and not limitation.

1. A system for managing computer performance, comprising:
a server connected to a network link;
a data storage device including:
a system activity database, said system activity database storing activity records and environmental records; and
an auxiliary database; said data storage device in communication with said server;
a client system in communication with said server;
a system monitor program executable by said server, said system monitor program including a user interface; and
a system activity analysis program executable by said server; wherein upon execution said system activity analysis program causes said server to search said system activity database and said auxiliary database, retrieve data relating to a request for analysis of a task, and present said data to a user on said client system.

2. The system of claim 1, wherein said activity records comprise fields including:
an activity record identifier;
an activity flag;
a unique task name;
amount of storage allocated;
name of initial program invoked;
a pointer to a list of additional storage requests;
a count of number of additional storage requests;
a pointer to a list of data sets used;
a count of number of additional storage requests;
a pointer to a list of locks used;
a count of number of additional storage requests;
execution start time; and
execution end time.

3. The system of claim 2, wherein said activity records are generated by said system monitor program in response to tasks executed via either of said client system and said server.

4. The system of claim 1 wherein said environmental records comprise fields including:
environmental record identifier;
environmental flags;
program/product name;
time stamp for change, addition, or deletion;
name of vendor for product; and
phone number for contact of said vendor.

5. The system of claim 4, wherein said environmental records are generated by said system monitor program via said user interface.

6. The system of claim 1, wherein said data stored in said system activity database are periodically transferred to said auxiliary database.

7. A method for managing computer system performance, comprising:
receiving a request to initiate a system activity analysis program;
invoking said program;
receiving a task name;
searching at least one database for said task name;
retrieving data associated with said task name; and
displaying said data to said user.

8. The method of claim 7, further comprising:
receiving a request to run a contention analysis report;
searching said database for data relating to said request;
displaying said data to said user.

9. The method of claim 7, wherein said task name is associated with an error encountered.

10. The method of claim 7, wherein said data associated with said task name includes information acquired during previous executions of said task.

11. The method of claim 10, wherein said information acquired is retrieved from an activity record for said task.

12. A storage medium encoded with machine-readable computer program code for managing computer system performance, the storage medium including instructions for causing the computer system to implement a method, comprising:
receiving a request to initiate a system activity analysis program;
invoking said program;
receiving a task name;
searching at least one database for said task name;
retrieving data associated with said task name; and
displaying said data to said user.

13. The storage medium of claim 12, further comprising instructions for causing the computer system to implement:
receiving a request to run a contention analysis report;
searching said database for data relating to said request;
displaying said data to said user.

14. The storage medium of claim 12, wherein said task name is associated with an error encountered by said computer system.

15. The storage medium of claim 12, wherein said data associated with said task name includes information acquired during previous executions of said task.

16. The storage medium of claim 15, wherein said information acquired is retrieved from an activity record for said task.
